(19) United States
(12) Patent Application Publication
(10) Pub. No.: US 2015/0316944 A1
(43) Pub. Date: Nov. 5, 2015

(54) Smart Electrical Panel Enclosure

(71) Applicant: Michel Raymond Thellend, Mountain (CA)

(72) Inventor: Michel Raymond Thellend, Mountain (CA)

(21) Appl. No.: 14/269,060

(22) Filed: May 2, 2014

(51) Int. Cl. G05F 1/66; G05B 15/02

(52) U.S. Cl. CPC G05F 1/66; G05B 15/02

(57) ABSTRACT

A self-contained smart electrical panel enclosure has two or more circuit breakers each having terminals, a back plate for mounting breakers and other devices, an openable protective breaker cover within a larger openable protective enclosure cover over the breakers and other devices, a power meter-display for each breaker connected to the terminals, for monitoring the circuit characteristics of the panel mains and individual loads, and connected to each power meter-display, for displaying circuit characteristics.

### FIELD

The invention relates to electrical and generator panels, smart meters, load misers, load shedding, power and control, through AC or DC access ports.

### BACKGROUND

Prior art electrical panels have a number of circuit breakers and control this power distribution throughout a building, however a professional must be retained to remove the electrical panel cover to take current, voltage, power (wattage) and kWh readings. There is a significant risk of shock in carrying out these measurements. In addition, cumbersome additional equipment such as voltmeters, ammeters, multimeters or voltage and current sensing devices are required for these measurements. This is all without mentioning the cost of a professional taking time to take all these measurements.

Prior art electrical panels lack a means of prioritizing some or all circuits within—aside from manual control of the breakers, either all, some, or none are powered. There is no means of automatically preferring certain circuits over others except with the use of externally mounted electrical devices. There are load miser systems that consist of a preferred load and a non-preferred load. If the combined loads exceed 80% of the fuse rating of the device, the non-preferred load will cease to operate. In the case of a generator feeding an emergency generator panel through a transfer switch, there is no means of automatically preferring certain circuits over others—aside from manual control of the breakers.

For example, Publication WO2013067120 describes adding or shedding loads connected to a generator. The method includes whether to change a number of loads based on the load that is supplied by the generator. However, the prior art electrical panels have some drawbacks, for example i) they are not self-contained, in that the componentry is not within a single housing; ii) circuits are limited in how they are prioritized independently of one another, in how many circuits they can control and configurability; iii) some systems are tied to particular generators and are not able to operate with generally-available generators; iv) the prior art systems cannot prioritize loads depending on time of day, or preventing scheduling of loads such as AC compressors with intermittent loads such as stoves; and v) lack the ability to prevent loads or entire circuits from being turned off during Hydro Peak, Mid, Normal usage times. As well, prior art units are often externally mounted, leading to added complexity and cost.

Further, prior art electrical panels use separate components like transfer switches, generator sub-panels, surge protection, metering control, and other externally mounted devices. For effective monitoring and control of usage on grid-wise basis, an electrical panel should be compatible with utility smart meters to reduce or eliminate power consumption at certain times of the day.

As there are many sources of electricity in a modern house, including renewable sources like solar or wind, particularly in rural areas, an electrical panel should be able to accommodate sources of varying voltage and power characteristics. In addition to coping appropriately with low power, electrical panels should provide surge protection for the building, which eliminates the need to rely on surge protectors for individual outlets. Prior art panels do not provide comprehensive surge protection.

Prior art panels do not provide notice of the power consumption of the panel as a whole, nor of the individual circuits, and do not provide usage data and history along with notice of abnormalities to a smart phone or other device. Prior art load miser systems lack the ability to time delay sensitive loads such as when a stove (a preferred intermittent load) and compressor (non-preferred load) are used together. Prior art electrical panels do not come with a software that can enter or edit breaker information in single or tandem breaker configuration, and print panel labels for loads and for as many circuits the panel can hold. They do not provide a computer graphical user interface duplicating the exact look and feel and allow access to functions, like being at the panel itself. Nor do prior art electrical panels come pre-wired at the circuit breakers and capable of installation with reconfigurable loads to a labeled barrier strip, and they do not have moisture or other sensors within the enclosure and dwelling to alert the user of conditions, via smart phone or other device.

Prior art electrical load misers are used to shed loads within a dwelling as a result of the main electrical panel's inadequacy to handle higher ampacities. Many people, and especially in apartment buildings, still have 60 AMP services or less supplying their demand. With the advent of many new types of appliances over the years, consumers purchase multiple high demand products such as a microwave, dryer, central NC unit, and many others, and are installing them in apartments, and other small units with inadequate power. Many small panels simply cannot meet the demand of the combined products. Higher ampacity than the main panel's rating through too many circuits supplying loads causes main breakers to nuisance trip and possible fires. Rather than rewire a house and install a higher service capacity, a load miser may be used to prefer one load over another when the current draw of both loads simultaneously would overload the circuit. Traditional load misers are wired with a main breaker from the main electrical panel, and wires for loads that will be used in the load miser need to be relocated from the main panel in order for system to function.

Prior art electrical load misers lack a means of controlling or shedding multiple loads. There are usually only 2 loads in the load miser, 1 preferred, and 1 non-preferred load. As an example, if the combined loads exceed 80% of the fuse rating of the device, the non-preferred load will not operate. Load misers are usually rated for not more than 60 AMPS.

Further, prior art electrical load misers are separate components. The system is often installed close to an electrical panel as the system needs to be fed with a main breaker. A main line can be run from an electrical panel to a location with 2 loads needing control, and load wires cannot be reconfigured from the electrical panel. Loads that are used with a load miser may be a stove, hot water tank, dryer, and others, with the stove often being the preferred load as it frequently has the highest demand within a dwelling. All of the aforementioned circuits would need to be removed from the main electrical panel and added to the load miser in order to be controlled. This adds cost in labor and materials to the installation.

Prior art electrical load misers lack a means of prioritizing loads. For example, the stove has priority over the dryer and NC unit, dryer has priority over the NC unit, but prior art load misers lack the ability for current control, time-control, and time delaying the NC unit in both aforementioned conditions.

Prior art load miser systems do not come pre-wired with labels and adequate length wires to reach breakers within an electrical panel, a wiring kit with labels, compression fittings and heat shrink to join wires in a panel for quick and easy installations of circuits needing control. Nor are they capable of allowing connection and monitoring of all loads through only one conduit attached to the main electrical panel. Prior art load misers do not come with multiple load capabilities, expandability and configurability, have current adjustability of every load from 6-60 AMPS or more, time delay in Sec, Min, or Hrs.' for sensitive loads, momentary switch to bypass a time delayed cycle, non-preferred load indicator light all within one unit, and require an additional main breaker to function. Furthermore, prior art load misers do not have hinged covers, a keyed lock for easy access, convenient repairs, and added safety. Traditional load misers will also not perform with a generator as the load miser is fixed in supply and load ampacities and exceed that of most standby generators.

For the prior art load miser, a higher ampacity main breaker is required, relocation of the load wires and removal of the breakers are needed. As a result of having only two loads in the load miser such as a stove and dryer, the NC unit has to remain in the electrical panel. This high-powered load and other loads could still trip the mains. More load misers would need to be installed, but proper control would not be achieved as the preferred loads, in two load misers for instance, could easily pass the main electrical panels ratings regardless.

Therefore there is a need for a cost effective load miser that permits full prioritization of multiple loads, prevention in relocation of loads from an electrical panel, prevention of installing multiple external load misers, is pre-wired for quick installation, allows expandability and configurability, current adjustability for every load with time delay for sensitive loads, easy access, added safety from electric shock, that will work in conjunction with generators to allow prioritization of multiple loads within a dwelling. A timer system could be installed in order to time loads at certain times of the day.

Regarding generators, in a prior art method, and if no transfer switches or emergency sub panels are used, extension cords are run from the generator to loads that need to be operated. Where there is an automatic transfer switch built in to an electrical panel or externally mounted, or generator sub panels are used, breakers would have to be turned off and on in the panels to accommodate the generator as generators may not be able to meet demand. When using smaller generators, many breakers would need to be disengaged or re-engaged in order to not exceed the generator's capabilities. The use of extension cords can be hazardous to individuals as they are normally underrated, easily damaged, and pose a tripping hazard.

Furthermore, prior art electrical power generation systems come in many varieties such as portable RV and residential/commercial generators, standby systems, PTO generators, vehicle mounted generators, two bearing, and welder generators. When power is unavailable for extended periods of time, demand for generators suddenly increases. Generators need regular maintenance, plenty of fuel, can be quite messy and dangerous when adding oil and fuel, are prone to theft, can be difficult to start, and are very noisy. If a generator breaks down during an extended power outage, parts will be hard to come by and near impossible to get in time for when the energy is needed for cooking, refrigeration, etc.

Prior art alternative power systems such as inverters with battery bank, solar power, wind turbines, and water generators do well to provide power when hydro utility power is down temporarily. Here again, if faced with an extended power outage these systems are dependent on many factors such as battery bank storage size, availability of sun, wind, water flow, and many others. There are inverter systems that can produce very high amounts of power at 120/240 VAC but most have small systems, roughly 2500 Watts per inverter or 20 AMPS each, with a small emergency sub panel to supply critical loads in a power outage. Many systems are not 240 VAC, rather 120 VAC. Generator systems can work well with the aforementioned alternative power systems to charge battery banks but few people have a generator and normally rely on power reserves or weather conditions to maintain loads. In addition to this, generators need to be of a higher caliber as far as peak voltage and regulation are concerned as they will not work for charging battery banks in alternative power systems, private vehicles produce DC and will charge a battery bank. This, in addition to the fact that generators need maintenance, break down, hard to start, and are messy. A private vehicle may be used to power an inverter and run extension cords into a dwelling to supply small loads such as a sump pump in order to avoid flooding, however automotive alternators are not made for such a load and may be damaged from excess draw of loads as there are limitations to vehicle alternator protection circuits. Isolators need to be installed in the vehicle to prevent draining the vehicle battery as well. Extension cords can cause trip hazards, can become easily damaged, and could electrocute someone as they may not have GFCI protection. Alternative power inverter systems are silent and dependable when used in conjunction with vehicles as a charging means just adds to the silence of power generation for a dwelling.

Prior art power transfer systems usually come in the form of manual or automatic type transfer and will allow a person to change from hydro utility power to another power source. Transfer switches can be installed ahead of a main electrical panel to feed circuits within an entire dwelling if a generator can supply the demand. If the generator is smaller, then breakers would need to be turned on-off to accommodate the generator. Many people have the main electrical panel and a small generator feeding a small transfer switch that is then connected to an emergency sub panel to manage critical loads. Transfer switch sizes are relevant to the ampacity of the main electrical panel, generator or alternative power source, and other factors. There are no known residential or commercial DC power transfer systems, switch or otherwise, to take power generated from a vehicle alternator safely and effectively into a dwelling to charge batteries in alternative power systems, or in reverse, charge vehicle batteries.

Therefore there is a need for an easy, safe, quiet method of transfer to provide continuous dependable high DC power to and from a building that permits bidirectional charging of battery banks or vehicle batteries, using any vehicle and alternator combination as a generator, or to provide straight power to inverters without battery banks in alternative power systems to supply 120/240 VAC for critical loads within a dwelling during intermittent, and especially extended power outages. This system will work well with a properly designed load prioritization system (load miser), to control as many loads as possible within a building.

In addition, there is a need for a smart electrical panel enclosure that permits observation of circuit characteristics without risk of electric shock, as well as providing surge and possibly lightning protection, automatic transfer switching capabilities, load prioritization with timer and time delay functions, communication to electronic devices, observation of enclosure and surrounding conditions, be expandable and configurable, compact and cost effective to install, with smart power consumption control, all within a single unit. It would be beneficial if the enclosure is also able to provide circuit management through a graphical user interface.

### SUMMARY

A self-contained electrical panel enclosure has two or more circuit breakers each having terminals, a back plate for mounting breakers and other devices, an openable protective breaker cover within a larger openable protective enclosure cover over the breakers and other devices, a power meter-display for each breaker connected to the terminals, for monitoring the circuit characteristics of the panel mains and individual loads, and an interface connected to each power meter-display, for displaying the circuit characteristics.

In an embodiment the power meter-displays have one or more buttons for changing to values shown, capable of reading the values displayed simultaneously and independently. The panel may also have a transfer switch to transfer from a first source to a second, alternative power source, wherein the transfer switch automatically transfers to the second source when the first source fails. The panel may have one or more relays for prioritizing and timing loads, wherein certain loads are prioritized and timed by connection to the relays.

In an embodiment the panel also has a microcontroller for controlling loads, wherein the relays are power relays, current control relays, timer relays, or time delay relays that are controlled by loads or a microcontroller. The microcontroller may be connected to the power meter-displays and receive information on circuit characteristics for logging and viewing.

In an embodiment the panel has environmental sensors for sensing the environment in and around the panel detecting abnormal environments, and a signal apparatus for signaling and communication of an abnormal environment.

Also disclosed is an exterior DC service entrance for using an automobile as a generator for a building that has an electrical panel positioned within a building, a transfer switch to switch between a house power source and an automotive power source, electrically connected to the electrical panel, an inverter system for converting DC power to AC power connected to the transfer switch, an alternator overload protection circuit connected to the inverter system, for connecting to the automotive power source, wherein the automotive power source is electrically connected to the protection circuit, and the transfer switch transfers automotive power to a building electrical panel.

In one embodiment the panel has a prioritization system for prioritizing loads, and/or has a second electrical panel for emergency circuits. The DC service entrance may have a current sensor and a power relay connected between the automotive power source, the transfer switch, and the inverter system, wherein the power relay stops current flow when the current sensor signals an excessive current draw.

In an embodiment the DC service entrance has a weatherproof enclosure having a lockable enclosure cover, wherein the electrical panel, the transfer switch, the inverter system and the protection circuit are in separate enclosures within the building. It may have the electrical panel, the transfer switch, and the protection circuit in one enclosure.

Further disclosed is a load miser for use with the electrical panel, having an enclosure, two or more relays, one or more preferred loads within the enclosure, connected to and controllable by at least one relay, and one or more non-preferred loads within the enclosure, connected to and controllable by at least one relay.

The enclosure may be pre-wired for connection with a kit to an electrical panel, having a wiring kit with labels, compression fittings and heat shrink to join wires. In an embodiment, the load miser may have a microcontroller for controlling the relays, and may have current sensors for monitoring load on the preferred circuit breakers. It may have current sensors for monitoring load on the non-preferred circuit breakers, and may have time delay relays for controlling sensitive or compressive loads.

Also disclosed is an electrical system for alternative power sources, having an electrical panel enclosure that has two or more circuit breakers each having terminals, a back plate for mounting breakers and other devices, an openable protective breaker cover within a larger openable protective enclosure cover over the breakers and other devices, a power meter-display for each breaker connected to the terminals, for monitoring the circuit characteristics of the panel mains and individual loads, an interface connected to each power meter-display, for displaying the circuit characteristics, further having an exterior DC service entrance for using an automobile as a generator for a building, that has a transfer switch to switch between a house power source and an automotive power source, electrically connected to the electrical panel, an inverter system for converting DC power to AC power connected to the transfer switch, an alternator overload protection circuit connected to the inverter system, for connecting to the automotive power source, wherein the automotive power source is electrically connected to the protection circuit, and the transfer switch transfers power from the automotive power source to the electrical panel, also having a load miser connected to the electrical panel that has a load miser enclosure, two or more relays, one or more preferred loads within the enclosure, connected to and controllable by at least one relay, and one or more non-preferred loads within the enclosure, connected to and controllable by at least one relay, for preferring loads within the building.

### DESCRIPTION OF FIGURES

FIG. 1 shows the front view of the enclosure, with the cover in place, according to one embodiment of the present invention;

FIG. 2 shows a detail view of a power meter display, according to one embodiment of the invention;

FIG. 3 shows an implementation of the power meter power meter-display within the enclosure, according to one embodiment of the present invention;

FIG. 4 shows the interior view of the enclosure, according to one embodiment of the invention;

FIG. 5a is a view of the power meter-display, display shield, and RS-485 network connections;

FIG. 5b is a view of the main microcontroller, Wi-Fi, and local network connections;

FIG. 6 shows an implementation of the system hardware and logic, according to one embodiment of the present invention.

FIG. 7 shows an implementation of a vehicle to house charging and inverter system with electrical enclosure panel, alternate external electric panel, transfer switch, and load miser, according to one embodiment of the invention;

FIG. 8 shows a cover of the DC Service Entrance, according to one embodiment of the invention;

FIG. 9 shows the front view of the load miser and alternate electric panel, with covers in place, according to one embodiment of the invention;

FIG. 10 shows the front view interior view of the load miser and alternate electric panel, according to one embodiment of the invention;

FIG. 11 shows an implementation of a load miser system, according to one embodiment of the invention; and

FIG. 12 shows an embodiment of the software for the enclosure, according to one embodiment of the present invention.

### DETAILED DESCRIPTION

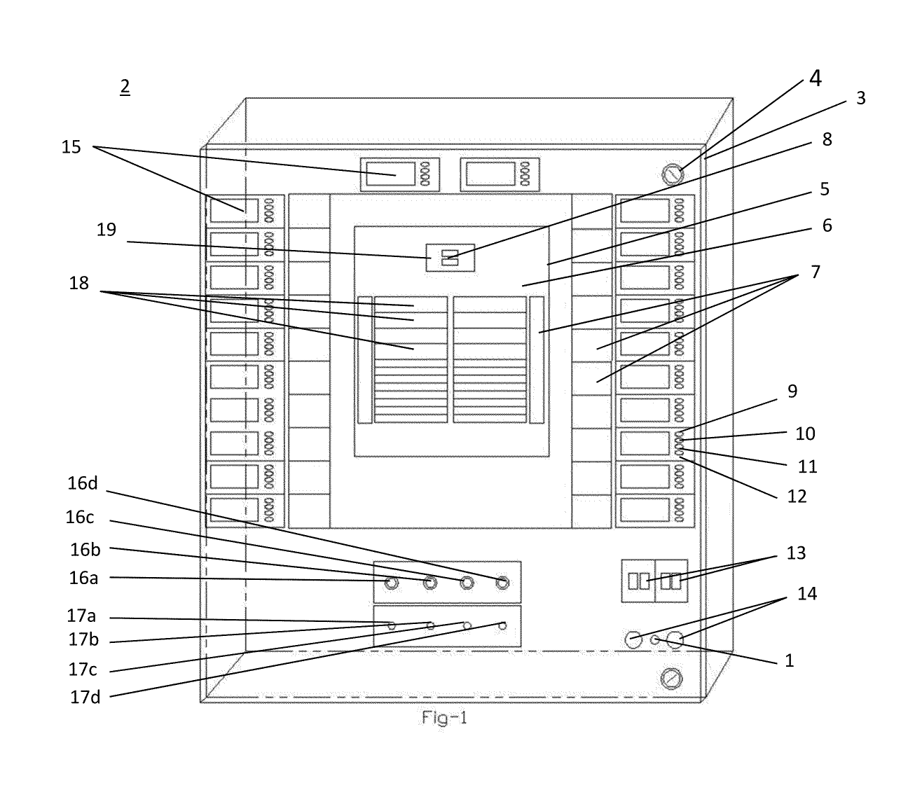

With reference to FIG. 1, the enclosure 2 disclosed provides a series of circuits and breakers to act as an electrical panel in controlling the circuits of the building in a single location. An electrical panel enclosure 2 having a protective, openable cover 3, having a second openable cover 6 in a fixed cover 5 therein, a back plate 30 (not shown) for mounting and an aperture 19 over the breaker panel 47 for ease of access. The openable cover 3 may be hinged and have keyed locks 4 to prevent unauthorized entry, to hold the openable cover 6 that may have a positive clasp or fastener (not shown) over the breakers, which is releasable by a person seeking access, such as an electrician. The breaker cover 6 (not shown) provides access to the breakers 18 and the master breaker switch 8, which controls the current through the breaker panel 47 even when openable cover 3 is closed. The breakers 18 are marked with numbers 7 at the side of the breaker panel 47 for ease of reference. The breakers 18 and master breaker switch 8 fits within the enclosure 2 in order to control the flow of electricity within the building. At either side of the breaker panel 47, are a series of power meter-displays 15 each corresponding to main L1, L2 above the fixed cover 5, a circuit, and a breaker 18 within the fixed panel 5. In an embodiment, clear Plexiglas™ or other plastic is present on the inside back openable cover 3 and/or on the inside of enclosure 2 in front of back plate 30 to protect from electric shock. The enclosure may also have an interior lighting system for safety. In an embodiment, there is a built-in receptacle on the side of enclosure 2.

Each of the circuits within the breaker panel 47 has a power meter-display 15 connected across the circuit (not shown), where the breakers 18 and 8 are connected. The power meter-display 15 has a number of sensors for determining voltage (V), current (A), power (W), and power over time (kWh) for the circuit, among other characteristics. These characteristics may be displayed within the power meter-displays 15 corresponding to that circuit, such that, viewing the enclosure from the front, it is immediately apparent what some of the characteristics of the circuits are. The power meter-displays are able to connect current transformers to read much higher currents. The readings are provided in power meter-displays on the front of the openable cover 3 and power meter-displays 15 may show the same characteristic simultaneously and independently across all power meter-displays, or each power meter-display may show certain characteristics independent of the others. Power meter-displays 15 may also be grouped, so some show identical characteristics, while others show individualized characteristics. Readings may be made without the need of connecting further sensors and risk electric shock, and without opening the openable cover 3.

The system is self-contained within the enclosure 2 and requires no external additions. Additional control buttons and lights/displays may be present on the openable cover 3 to control external power source systems and other devices. If there is a need to control an external contactor for lighting or power sources ahead of the main transfer switch in the enclosure, the panel buttons could be used with indication from pilot lights or displays.

The aperture 19 fits over the breakers 8, 18, while providing access to the master switch 8. The breakers are labeled 7 on the outside of the cover to ease the search for a particular circuit once the openable cover 6 is open. Each of the power meter-displays 15 corresponds with a main L1, L2 or a circuit. The power meter-displays 15 are also labeled 7 accordingly. The breakers are labeled 7 on the inside of openable cover 6 and on fixed cover 5 to ease the search for a particular circuit once the cover is open. In an embodiment, there may be a secondary automatic transfer switch system and main breakers within enclosure 2 to allow multiple types of alternative power sources to be controlled prior to entry in a secondary input source of transfer switch 33. For example, if two sources of alternative power are available (wind and solar), these sources could be on the line side of a secondary transfer switch (not shown), wherein the load side of the secondary transfer switch (not shown) could feed line side of transfer switch 33. The other side of transfer switch 33 would be a municipal electric source, such as hydro electricity. In this embodiment, a button on the front panel cover 3 would enable choice of which alternative power source would come into transfer switch 33 from the secondary transfer switch (not shown) before going into the enclosure 2 if the second transfer switch is mounted externally. The second transfer switch could be installed in enclosure 2.

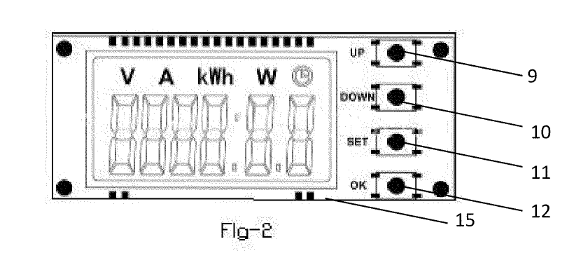

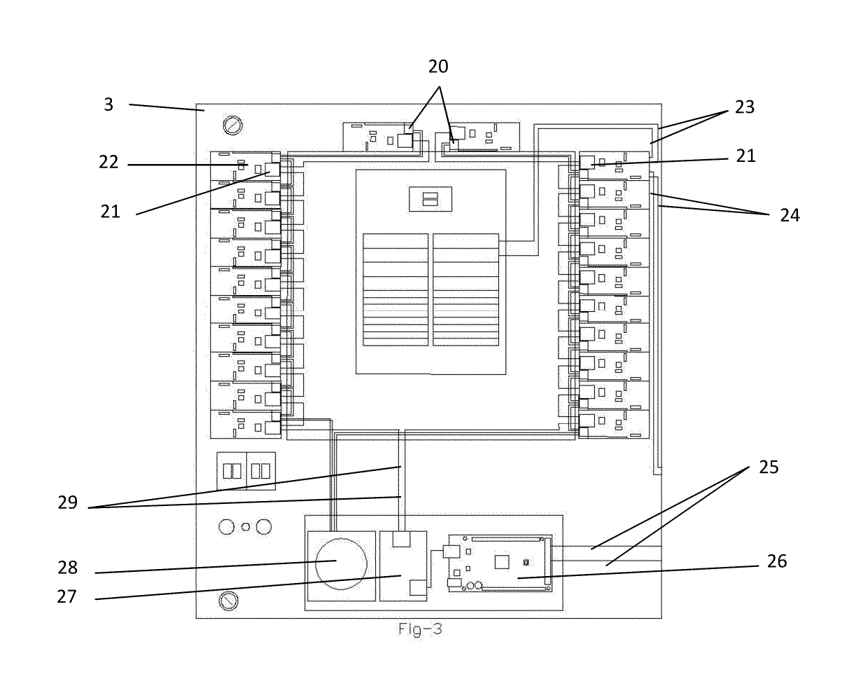

With reference to FIGS. 2 and 3, at the side of each power meter-display 15 is a series of buttons. In one embodiment, four buttons 9, 10, 11 and 12 are provided for scrolling through the data recorded about the circuit. In one embodiment, the buttons are labeled UP 9 (for scrolling up through the data types), DOWN 10 (for scrolling down through the data types), SET 11 (for choosing a data type, and scrolling through the time periods for the data type) and OK 12 (for lighting, selecting the data type, and time period). More or fewer buttons are possible depending on the configuration and features. A touch-screen would replace the functionality of the buttons and may be used instead of the power meter-displays 15. At the top of the power meter-display 15 is an indication of the unit type, in this example the readings are kWh's, voltage, kilowatts or amperes, and below is the data value in numbers. Lightning surge protection may be added to the system as well.

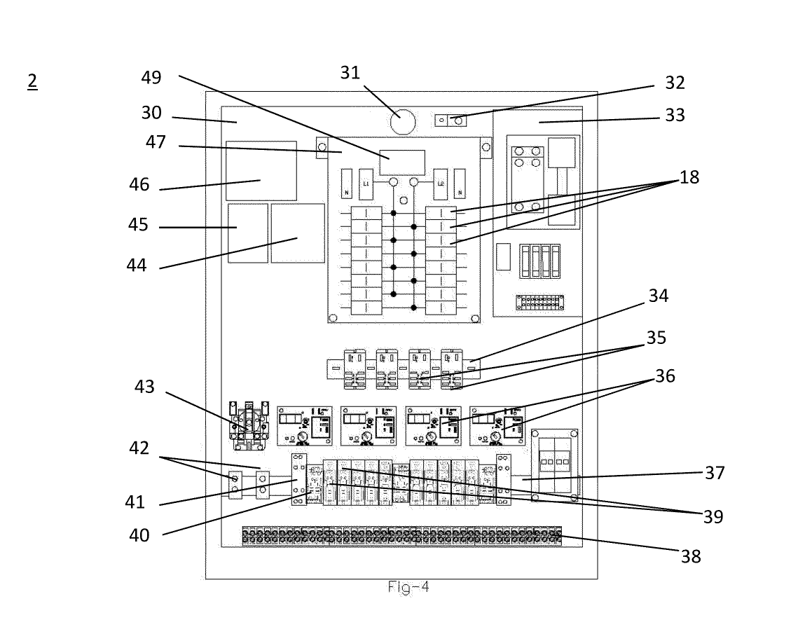

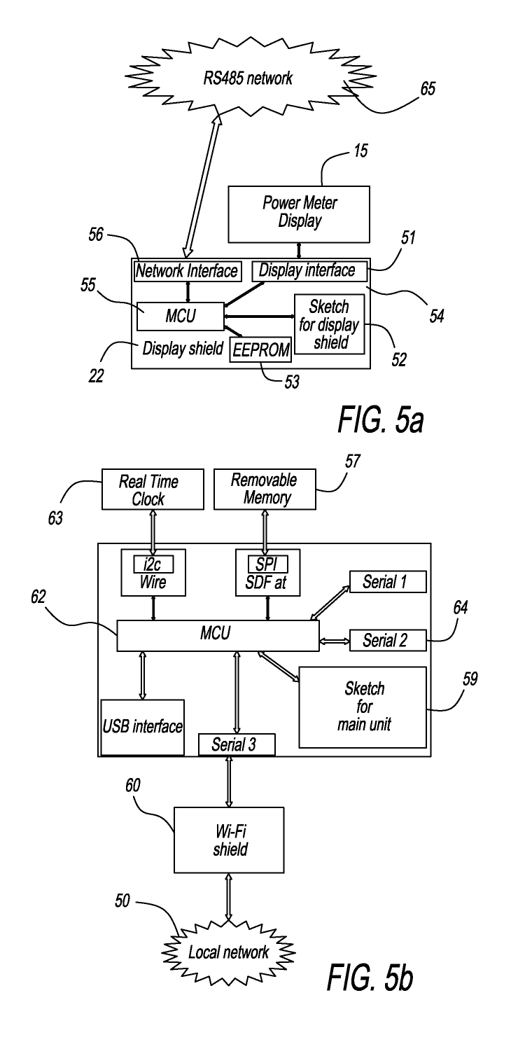

With reference to FIG. 4, the enclosure has an automatic transfer switch 33 to transfer the load to a different source, for example a generator or alternative power system such as battery inverter power, solar power or wind power. The transfer switch 33 transfers between two lines, as shown in the present embodiment, or three or more lines, depending on additional components and the desired configuration. A type 2 surge protection unit is also present from the source, to prevent damage from power surges within the building. The panel has transfer indicator lights 14 to show the status of the transfer switches selected source, and surge protection indicator light 1 showing the status of the surge protection. Lighting protection may be added as well.

Upon source failure, the transfer switch 33 automatically transfers to an alternative source, such as generator power, after either starting the generator automatically or being notified that the manual generator starting procedure is complete and the generator output stabilized. The generator now provides power to the entire building, and the load is prioritized based on the prioritization and microcontroller settings. In one embodiment the load is prioritized through one or more relays (shown in FIG. 4), which become active once the transfer switch transfers to an alternative source. In an embodiment, a secondary automatic transfer system and accompanying main breakers may be added within the enclosure 2 to allow multiple types of alternative power sources to be controlled prior to entry in transfer switch 33 secondary input source. In hydro utility mode, the main circuit relay system can be controlled by the main microcontroller using a smaller relay system to control loads at various times of day.

The enclosure 2 may have one or more environmental sensor and controller 44 as well, such as flame, smoke, or moisture detectors to determine if flame or smoke is present, or moisture is present, particularly in the lowest levels of a building, or other detectors for monitoring power such as generator or alternative source power frequency, vibration, tilt, temperature, pressure, position, magnetic, proximity or motion detectors. Sensors may also be used for transducers or current transformers. When a signal is received from the controller 44, the master indicator 17a-17d (shown in FIG. 1), will indicate with lights the nature of the notification. Furthermore, a notification may go out through Wi-Fi or SMS for example, regarding the environment directly in or around the panel. In one embodiment, the indicator lights 1, 14, and 17 may be substituted by a master power meter-display (not shown), such as a 10″ LCD screen, for the enclosure 2. A series of master power meter-display buttons 16 is available on the enclosure 2 to allow the user to scroll through menu options using OK 16a, SET 16b, DOWN 16c and UP 16d buttons, as described above. The buttons 16a-16d control power meter-displays 15 for simultaneous readings, settings such as logging, alarms, or lighting. Pushing the master power meter-display buttons 16 will change the settings on all individual power meter-displays 15 so the same measurements are displayed for each circuit, provided the power meter-displays 15 are on the same settings to start. Otherwise, the buttons 9-12 on the power meter-displays may be used to show different measurements on different power meter-displays 15.

The panel also has nylon barrier strips 38 for an electrician to connect loads, in one embodiment located at the bottom of the back plate 30. The nylon barrier strips 38 shown on FIG. 4 allows the electrician to connect all loads to the barrier strip 38, and terminal blocks 42, rather than at the breakers 48, in an embodiment where the system is shipped pre-wired.

The panel is prewired for the appropriate circuits for a particular use, so configuration need not be performed on site, however the panel also has knockouts with KO fillers for an electrical contractor to connect to the system. The electrician connects the loads to a barrier strip 38 at the bottom of the panel enclosure (bottom entry) rated up to 30A for loads or up to 40A using terminal blocks 42 for a stove, for example. There is no need for the electrician to wire up to the breakers, and the barrier strip 38 is identified with the breaker numbers and the loads they are pre-configured to handle. Both the wiring in the enclosure and software can be re-configured onsite.

With reference to FIG. 4, the enclosure 2 is shown without the front openable cover 3, to enable the back plate 30 and components to be seen. The main breaker panel 47 is shown at the center of the enclosure 2. Adjacent to the breaker panel 47 is an automatic transfer switch 33 for transferring the source from a first source to a second source (typically a generator). When the transfer switch 33 selects between a first and a second source, the transfer indicator lights 14 illuminate accordingly.

The enclosure 2 has a number of supply breakers 13 corresponding to the number of sources (hydro power, alternate sources such as generator power, solar or wind power). These supply breakers 13 are the first point of control for the incoming source power and control the power that is transmitted to the breaker panel 47, before the power passes through the panel breaker switch 8.

Within the enclosure 2 is a system of DIN rails 34, 37 for mounting relays and terminal blocks. The relays allow prioritization and control to be engaged. The relays may consist of one or more main power relays 35, 45, adjustable current control relays 36, and smaller load 39, 40 and time delay relays 41. In an embodiment, the stove, dryer, air conditioner, water pump, and spare are prioritized, while certain full-time circuits may not be prioritized, such as lights, electrical plugs, refrigerator, freezer, microwave oven and sump pump, representing critical loads. Time delay relays 41 are used for any sensitive or compressive loads. The relays may be controlled by a microcontroller, directly or through a secondary relay system timing loads to operate at specific times of the day, week, month and year.

The electrician connects supply lines to the main breakers 13 at the bottom of enclosure 2 rather than to the main panel breaker 8 as the supply breaker(s) 13, which are connected to the transfer switch supply side, takes precedence over the panel's main breaker 8. In one embodiment, the transfer switch control board 46 is also located at the top of the panel for control over the transfer switch and auto-start generator sets. The enclosure 2 also has a surge protector 45 as well as environmental sensors 17a-17d and sensor control board 44. Information about the surge protection is given through surge protection indicator light 1 and information about the environmental sensors is given by the master indicator lights 17a-17d.

With reference to FIGS. 3, 4, 6, the enclosure offers control over individual circuits within the breaker panel 47. Each circuit has a breaker with a power meter-display 15 connected to each of the terminals of the breaker directly, and using current transformers for higher ampacity loads, with a further connection from the power meter-displays 15 to the loads through the relay systems 35, 36, 39, 40, 43 with or without time delay 41, and through the barrier strip 38. A connection from the power meter-display 15 to the power meter-display shield 54 is achieved through a custom pin header assembly 51. The data from sensors 70a-70d is converted in the sensor unit 44 from serial to USB serial data through twisted pairs of CAT cable 29 derived from the power meter-display 15 and power meter-display interface 51 corresponding to the specific power meter-display 15 interface address. The power meter-display 15 has its own circuitry and microcontroller to measure, collect, and store data. The custom display shield 54 with its own microcontroller interprets the power meter-display 15 data from the power meter-display segments data, is then converted to serial data to be further interpreted to and from master microcontroller board 58, such that the microcontroller board 58 is able to duplicate the exact functions of power meter-display 15. Usage statistics such as volts over time, current over time, and power over time and logging the data in non-volatile memory for the circuit to be further be displayed or controlled in a software GUI. A separate power supply 28 supplies power to the power meter-display shields 54, main microcontroller 58, the serial to USB converter 27, and any other DC loads requiring DC power through power lines 20.

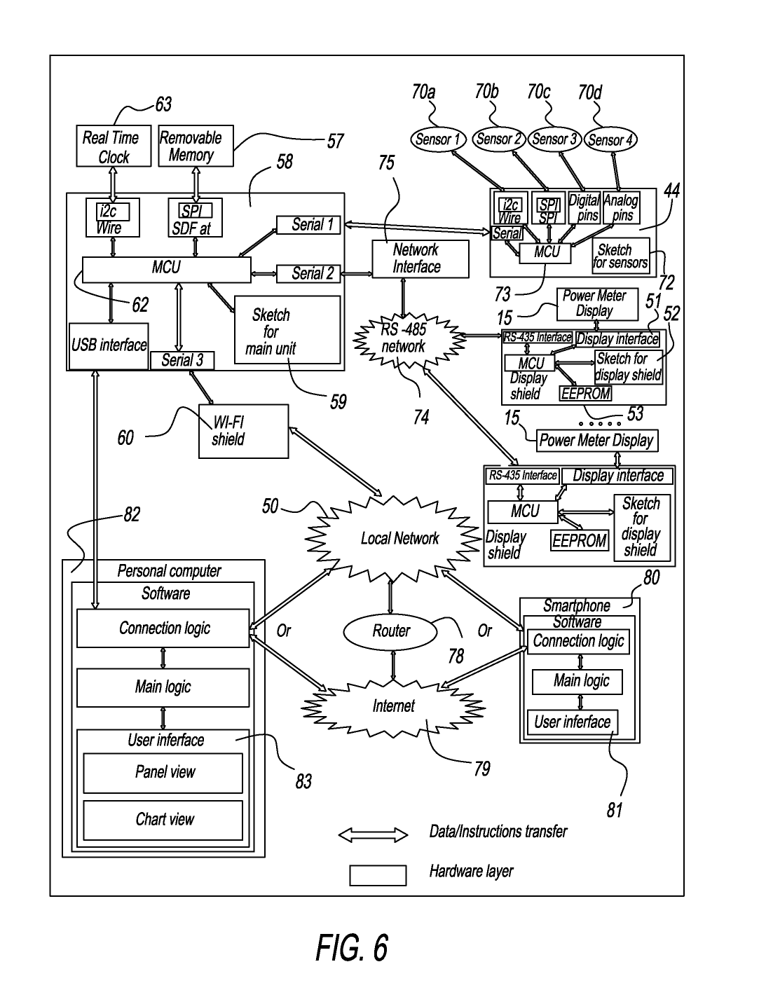

With further reference to FIG. 3, 4 and FIG. 6, each circuit has a breaker line 65 and load 66, also a connection to the corresponding power meter-display 15, the power meter-displays 15 having a connection to each of the terminals of the breaker 18, then to the loads with or without a connection to the relays, and a microcontroller power meter-display shield 54 to convey information from and to the microcontroller. With reference to FIG. 1, in one embodiment, the panel has one or more master buttons 16 that set all power meter-displays 15 to show the same measurement, such as current throughput, in the display and software GUI, independently or simultaneously.

In an embodiment, current and voltage transformers (not shown) are present on some or all lines between breakers and loads, and are wired to the same power meter-displays 15 or a single, higher-end meter (not shown) showing more detailed power characteristics by means of the higher-end meter. Alternatively, the circuits are wired in groups and report to one of several higher-end meters. The drawback of this embodiment is the cost of further meters, current transformers, expensive PLC systems, and the ability to view characteristics of all circuits, or only a group at a time, rather than individually. A larger main power meter-display to replace 15, such as a 10″×6″ LCD, may be used in order to show the information from the higher-end meter and transformer-enhanced circuits, circuit-by-circuit, overcoming the limitation of a single or several higher-end meters. The use of higher-end meters also increases cost over the first embodiment described above.

With reference to FIG. 4, the power relay section operates using current controlled relays, timers, and time delay relays. The smaller loads are turned off in groups to prioritize, depending on what power relay is energized. For instance, if the stove is on, then all other loads on the prioritization system will be off and time delayed because of the stove's power requirements and intermittent nature. If the dryer is on then all other power loads will be turned off depending on the current setting of the current controlled relay. The current controlled relay can be set to sense dryer motor current and/or heating element current, and will turn off subsequent loads accordingly and a different group of smaller relays. If just the A/C unit is on, then any subsequent power relays will be off including another different group of smaller relays as the NC load is not as demanding as the stove or dryer. Any compressive load such as a fridge or freezer, whether the preferred load is intermittent or not, will be time delayed to help prevent both simultaneous and standalone cycling of compressors. The smaller relays can also be set to prioritize by having the first relay energize or de-energize a subsequent relay down the line without the need of current controlling. Prioritization can be customized according to the intended use. In one embodiment a current sensing relay senses a load which in turn energizes a relay built in, which provides power to perform other tasks. In one example the relay feeds the coil of the next relay from its contacts while managing a load on its contacts at the same time, and also turning a load or multiple loads on or off whilst energizing a further relay. The main microcontroller can override any configuration mentioned above.

The loads may be prioritized so as to enable some circuits to receive power while others are effectively switched off. Loads may be in an off state, an on state, a timed state, and a time delay state. Whether a load requires prioritization or not is determined by the current controlled relays, which are first set to the generator's capacity (0-100 A for example). The remaining current controlled relays and power relays are set to their respective load or user settings. Loads are prioritized and can be in an on, off, timed, or time-delayed state. What will essentially determine if a load needs to be prioritized or not is the current controlled relays 36, and the main microcontroller board. The generator current control relay will be set to match the generator's capacity, 0-100 AMPS. The other current controlled relays will be set to their respective load and/or user current settings. It is the loads, smaller and time delay relays, power relays, current controlled relays, and timer relays that will determine when and what loads, large or small, will be turned on, off, or will be time delayed. High end loads will pass through the current sensing relays, in turn performing other actions including controlling further relays.

The software controlling the microcontrollers, which is open-source in an embodiment, can send instructions through sketches to program the microcontrollers and control the power meter-display functions of each power meter-display 15, through the microcontroller and display shield. Further, the power meter-display 15, features can be operated remotely through a GUI on a computer, for example. With reference to FIG. 6, in one embodiment the microcontroller board 58 is mounted on the back of openable cover 3 and communicates with the power meter-displays 15, through a power meter-display shield 54. The microcontroller may have an EEPROM 53 for firmware, and the microcontroller board 58 communicates with the network 50 through a transceiver 75. The microcontroller board 58 communicates wirelessly with external peripherals such as laptop computers or smartphones, using one or more known protocols such as Bluetooth™, Wi-Fi, for example, or by known wired means in order to provide for full system control. All information that is processed through a power meter-display 15, of the system also is passed to the microcontroller board 58, which can provide a full set of circuit information to an external peripheral. It also communicates wirelessly with devices throughout the house capable of wireless communication such as the thermostat, to control appliances or determine further information on the status of the building. The enclosure and microcontroller therein provide a USB direct, wired connection to other USB devices, connection with Bluetooth enabled devices, network connectivity through Wi-Fi or other wireless protocols. The microcontroller is capable of sending and receiving messages through cellular phone networks using protocols such as SMS. RF may be used for communication with other devices within range. The data transmitted may be logged information and conditions within the enclosure in as far as source of power, alarm conditions, surge protection status, and functions from buttons pressed at the power meter-displays showing in the GUI and likewise buttons pressed in the GUI back to the power meter-displays.

With further reference to FIG. 6, the microcontroller 62, interfaces with the network 50 through a USB interface 27. It has connections for serial to USB 27, which may interface with a personal computer 82, for example. Also, the microcontroller 62 has a wireless network interface such as Wi-Fi 60, described above. Further, the microcontroller 62 may have access to expandable storage 57 such as SD cards or other non-volatile memory. The microcontroller 62 also has a connection to the system's sensors through sensor unit or interface 44, connected to one or more power metering or environmental sensors 70 described above.

The microcontrollers are controlled by software or firmware. In one embodiment the microcontrollers are programmed with a custom sketch using open source Arduino™ software. With reference to FIG. 6, an overview of the hardware and firmware/software system controlling the enclosure 2 is shown. The enclosure 2 has a series of sensors 70 which determine metrics of the electrical system or the environment of the enclosure 2. In the example embodiment four sensors 70a-70d are shown, wherein 70a has an i2c wired connection, 70b has an SPI connection, 70c transmits digital data, and 70d transmits analog data. All the data from these sensors 70 is transmitted to a microcontroller 73, which is relayed to the main microcontroller board 58, which contains the microcontroller 62. The data may be relayed by a serial connection. The microcontroller 62 provides input/output to the power meter-displays 15, through transceiver 47 and network interface 56. Each of the power meter-displays 15 have a power meter-display shield 54, which interprets the signals alternating to and from the power meter-display 15 through the network, and converts it to a displayable signal in the display or software GUI. The microcontroller 62 also communicates with a local network 50 through Wi-Fi 60, from which it may further communicate with computers 82 or smartphones 80 on the network 50, or access the Internet 79 via a router 78. The microcontroller 62 has capability of receiving removable memory 57 such as an SD card or a USB key, for which a SPI interface is used. Optionally, a real time clock 63 for logging, is interfaced through an i2c wired connection. The microcontroller 62 interfaces with a computer 82 through a USB interface 27 or other network connection, whether wired or not. The computer 82 communicates via a user interface 83 implemented on the computer, which gives the computer user control over the enclosure 2 operation, and provides real-time usage statistics and other information. Similarly, the smartphone 80 has a user interface 81 which gives the smartphone user statistics on the operation of the enclosure as well as control over the operation of the enclosure 2.

### Examples of Operation

In one embodiment, from breaker 18 (40 AMP D.P. breaker) the stoves L1 passes through an adjustable current sensors current transformer then connects to one side of the DPDT N.C. common position on the 40 AMP power relay 43. L2 is connected to the other N.C. contact. The adjustment on the adjustable current sensors dial is set to 20 AMPS (adjustable up to 60 AMP in this example). When an element is turned on it will draw approximately 10 AMPS and the current sensors 36 N.O. relay contact will not close allowing all the other loads on relays to function. If a second element is turned on for a total of 20 AMPS, the current sensor relay will close, which in turn will energize subsequent relays and open the contacts de-energizing pre-configured loads. Since the stove is a major appliance requiring much power, the demand on the generator will be high, especially if the generator does not fulfill the ampacity requirements of the electrical panels rated ampacity, and many loads will need to be de-energized to accommodate the stoves needs. All in the meantime some chosen loads will remain on such as lighting circuits and other crucial small loads.

At this point the subsequent heavy loads are off with possibly many of the smaller loads such as fridges, freezers, et cetera. The stove is an intermittent load as it functions on temperature sensors that when the stove elements reach that temperature the stove will not consume energy therefore the current sensors relay will close and open quite frequently. To protect heavy loads from cycling, and especially in the case of the NC unit, there is a time delay relay 41 with built in special timing cycles that will keep the heavier loads and the NC load off, even during cycling of the stove for a an adjustable pre-set time limit to allow the stove to cycle and oil to settle in the compressor before it can start again. If the stove is still on and cycling, and the timer reaches its pre-set limit, the timer will restart its timing cycle until the stove is off for the entire timing cycle. At no time will the other loads be on at the same time as the stove whether on time delay or not. If the stove is off then all the other loads will run if needed. If the stove exceeds the generator capabilities altogether, another adjustable current sensor set to below the maximum power capabilities of the generator (0-100 AMP current sensor) will turn the stove off (power relay 43) completely for a pre-determined time while allowing for some critical loads to still work. When this occurs all other loads may function as usual depending on configurations. Microcontroller board 58 can override any relay and time loads to function at specific times of the day, week, month, and year through the software GUI.

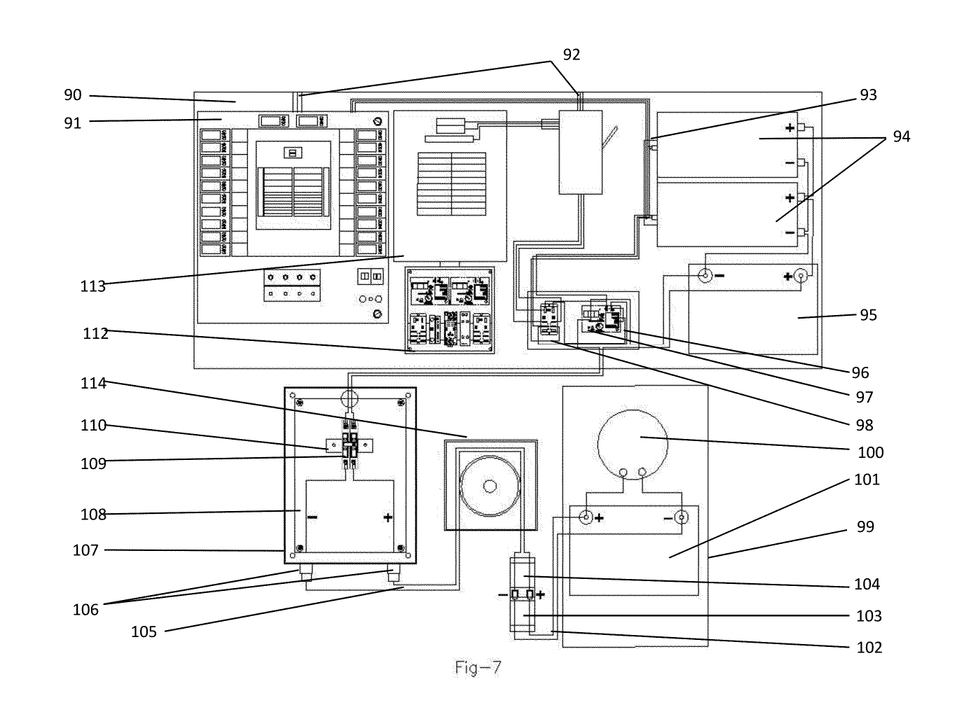

With reference to FIGS. 4, 7, an inverter system 94 is connected to a battery bank 95, is connected to electrical panel 113 through transfer switch 111, prioritization system 112, alternator overload protection circuit 96, a second electrical panel enclosure 91, all within the housing 90. The inverter system 94 facilities the use of an automobile engine as a generator. The purpose of two electrical panel systems 91, 113, wired in parallel is to show the difference in methods of connection using both types, and differences between, enclosure 2 and externally mounted devices, with hydro utility an alternative power sources as a supply. When the battery cables 105 pass through the line side of breaker 109 they then enter the building from the load side of the breaker 109. The cables 105 enter an alternator overload protection circuit 96, and the negative cable 105 enters an adjustable 0-100 AMP current sensor 97 with a relay to control a power relay 98 capable of cutting power at the AC output 93 of the inverter system 94, thereby protecting the vehicle alternator 100 from excessive current draw. A battery isolator may be installed to prevent the vehicle battery from draining. Vehicle alternators typically have voltage regulation and usually some form of overload protection but experiments show that a secondary system was necessary at the inverters output. At this point the power (in cables 93) from the inverters is present at transfer switch 111 regardless if the system is charging from a vehicle 99 or not. Under normal hydro utility power conditions 92, power is supplied to the panel 113 through the transfer switch 111, and the prioritization system 96 functions as well. If electric power 92 should become unavailable, then the transfer switch 111 is manually engaged in the alternative power source position. Power from inverter 94 would then flow through the panel 113 and prioritization system 112 to control loads respecting the inverter systems 94, output 93 capabilities. In the electrical panel enclosure 2, the electrical panel 47, transfer switch 33 (automatic), enhanced prioritization system with relays 35, 36, 39, 40, 41, 43, and alternator overload protection circuit 96, are all in enclosure 91 within the housing 90. In an embodiment, the panel 113, and prioritization system 112 may be controlled by a microcontroller, which may be controlled by a remote computer or smartphone. There may also be a high amperage switch (not shown) in DC Service Entrance 107 to disconnect power between vehicle 99 and 107. Inverters may come with built in chargers and transfer relays, there can be many configurations in these types of systems.

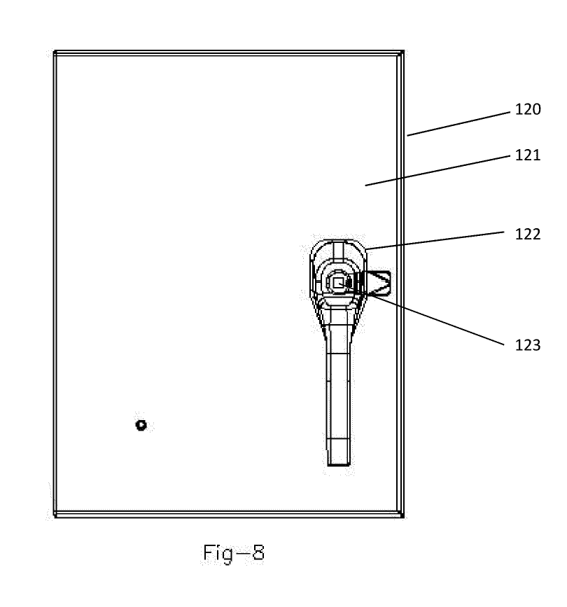

Furthermore, a DC Service Entrance provides a source of DC power transfer to and from any vehicle or DC power system, to a DC-AC inverter system in a building in order to supply power to critical loads as a generator or to charge vehicle batteries. The DC Service Entrance can transfer a source of power that can be used to supply the transfer switch in the electrical enclosure panel described above, or can use an external manual transfer switch, emergency sub panel, and the load miser system, which is incorporated into the all in one electrical panel enclosure described above. With reference to FIGS. 7, 8, an embodiment includes a weatherproof DC service entrance enclosure 120 with a back plate 108, and an openable front cover 121 having a handle 122 with key lock 123.

With further reference to FIG. 7, within the enclosure 120, there is a DC circuit breaker 109 mounted on a din rail 110 that is rated at equal the ampacity of a vehicle alternator battery combination. There are two strain relief connectors 106 that are used to accommodate the DC cables 105 that are rated for the system ampacity as well. The cables 105 are long enough to reach the front of a vehicle 99 in the driveway, and has a high ampacity quick release male connector 104 that connects to the vehicle's female quick release connector 103 for easy connection to and from the DC service Entrance enclosure 120 and the vehicle system 99. The vehicle cables 102 are connected to the vehicle's battery 101, which is connected to the alternator 100 for charging purposes.

When the DC cables 105 are not in use, the cables that are fastened together are wrapped around the hose reel or hanger 114 mounted adjacent to the DC Service Entrance 120. The breaker 109 is a means of disconnect for power to the male connector end 104, alternatively a heavy DC switch can be used ahead of the line side of the breaker 109. For the relatively few number of times that the system would be used under normal circumstances, using the breaker 109 as a means of disconnect would not cause excessive wear over time.

Private vehicles are highly capable for the production of power, able to provide in the range of 3000 AMPS at 12 VDC, this can easily power any 12 VDC to 120 VAC inverter system. Most alternators have a rating of approximately 100 AMPS or 1,200 Watts at 12 VDC if idling at a specific low RPM. This is still quite a bit of power to charge a residential battery bank. Higher voltage inverter systems with battery banks in the 24 VDC to 48 VDC range could easily be charged with the same 12 VDC private vehicle system using a battery isolator in the vehicle and DC to DC step up transformer in the building.

The DC Service Entrance may have a charge controller to regulate charge from any alternative power source to the inverter battery bank. Furthermore, dual breakers may be used for higher ampacity from a source, using a buss system in the service entrance to wire breakers with smaller parallel runs of DC cable. The alternator overload protection system may incorporate power meter-displays 15 for DC metering using shunt resistors, for monitoring power characteristics. The vehicle may have a battery isolator as well.

With reference to FIGS. 7 and 8, the hinged enclosure cover 121 that is attached to enclosure 120 is closed before, during, and after usage and lockable to prevent unauthorized entry by means of a handle 122. The alternator 100 can be upgraded to a higher ampacity or tandem alternators can be installed in a vehicle 99 to provide even higher amounts of power for charging purposes. A vehicle idler system can be installed to produce higher RPM's therefore increasing the charge rate to a battery bank. In addition to the benefits of added power for the system, the vehicle 99 will benefit as well from use. Alternatively additional batteries 101 can be installed.

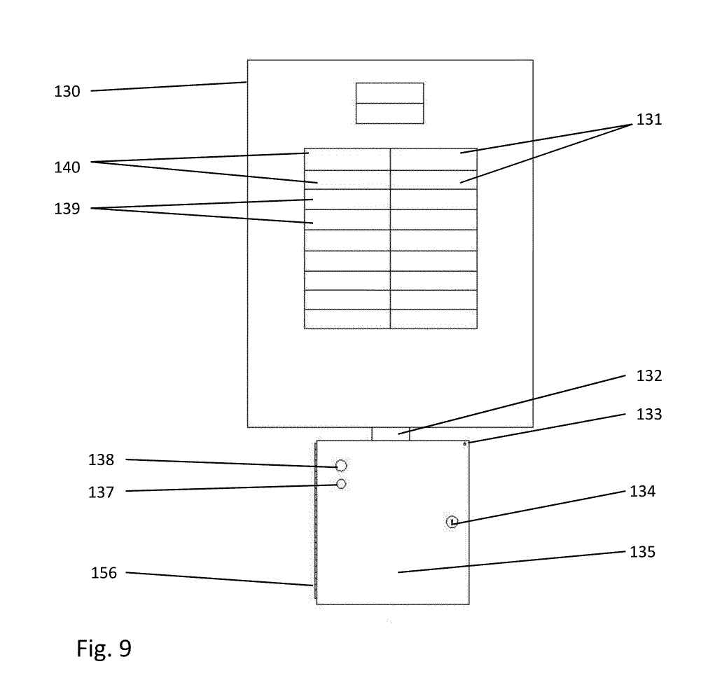

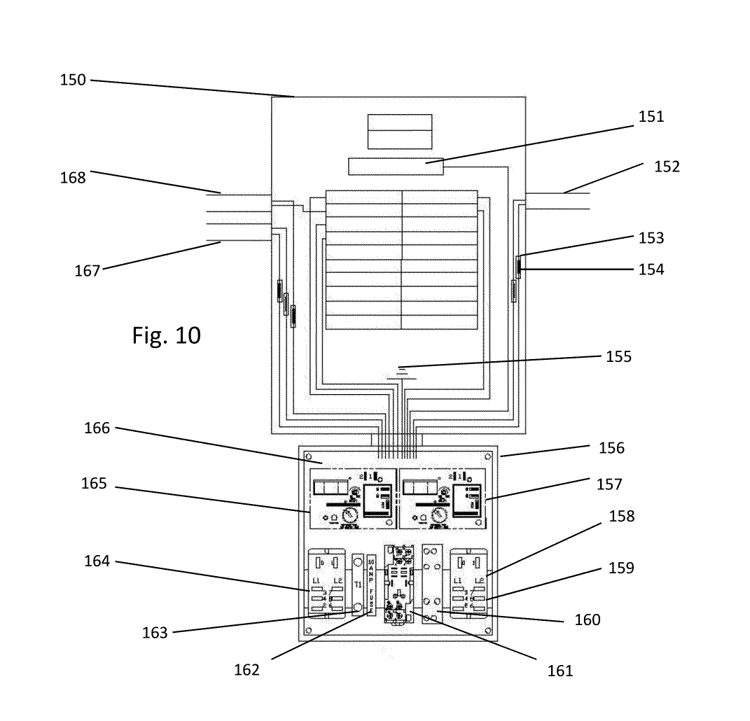

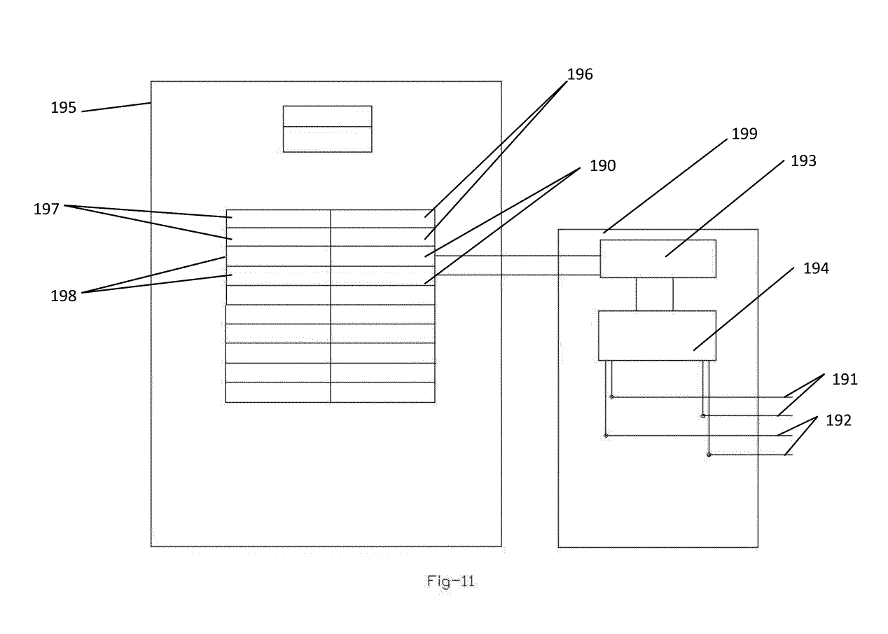

The load miser enclosure 156 disclosed provides, in a single unit, control to prevent overloading the mains of a building. With reference to FIGS. 9, 10, the present invention is an electrical load prioritization system (load miser) enclosure 156, attached to an electrical panel 130 by a threaded closed nipple 132 or flexible conduit (not shown). Circuit breakers 131, 139, 140 remain in the panel, and the wires for the lines and loads passing in and out of the conduit 132, connect the breakers and loads 131, 139, 140 and components within panel 130 and load miser 156. The openable cover 135 has a lock 134 to lock ably fasten the cover 135 to the housing 156, and a set screw 133, to prevent unauthorized entry. The hinged cover 135 over the devices is openable by key by a person seeking access, such as an electrician. The openable cover 135 provides access to the devices on back plate 166. The front hinged cover 135 is marked with an indicator 138 to indicate when non-preferred loads are off signaled by illumination of a red neon light. Number 137 is a N.C. momentary switch that resets a time delay relay in the event that a person does not wish to wait for the timing cycle to complete. This after the preferred load is off. The timing cycle will function for a preset time delay when prioritized loads are energized to protect sensitive loads such as compressors or motors.

The load miser connections are shown within the electrical panel 130 and are pre-wired. In one embodiment, L1 stove wire from the stove breaker 140 is connected to a terminal T1 163 on the back plate 166, then passes through the first adjustable current sensor 165 and returns directly to the stove load L1 168 wire to be crimped and heat shrunk. Stove L2 168 is connected from the breaker 140 directly to the load L2 168 wire in the electrical panel. The stove is the main preferred load and simply needs to be sensed. The dryer L1 wire that connects to the dryer breaker 139 passes through the second adjustable current sensor 157, then through the first power relay 164 N.C. common contact mounted on din rail 158. The dryer L1 167 load wire from the same power relay 164 N.C. contact connects to the dryer L1 167 load wire, and is then crimped and heat shrunk. Dryer L2 follows the same process as L1 and goes from the panel and back to the load through the second N.C. contact of the power relay. Multiple loads may be connected in the same way. The NC L1, L2 152 wires will follow the same path as the dryer but none pass through a current sensor, and only pass through the second power relays 159 N.C. contacts. Essentially, all lines from the dryer and NC breakers are connected to the N.C. common (normal state) contacts of the power relays 164, 159, and the load wires return to the electrical panel from the same N.C. contacts to be crimped 154 and heat shrunk 153 to the load wires going to the appliances. Relays 160 and 161 are control and timing relays. The power for all the devices comes from T1 163 which is then fed to a switch type fuse holder 162 before supplying the devices. The ground 155 and neutral wire 151 are wired directly to the panels buss systems. All wires are labeled at the relays, the wires passing through the threaded nipple to be connected in the panel, and at the breakers and loads wires upon installation as well for easy identification. In one embodiment, the load miser has an openable cover and lock to prevent unauthorized entry.

The load miser comes pre-wired, and there are no wires to relocate from existing panels into the new load miser. The load miser connects directly to an existing electrical panel to control loads. It can handle multiple preferred and non-preferred loads, loads can be timed, and prioritize, whereas traditional load misers have only one preferred and one non preferred load capability. Further, the present invention uses power relays and time delay relays to control the load power and time of power delivery to the load. A timer may be added to turn loads on and off during certain times of the day. For example, a timer system is microcontroller or relay based and controls loads in peak, mid and standard hydro periods to conserve costs. The monitoring and control of the load miser may take place remotely through Wi-Fi devices, computers and smartphones.

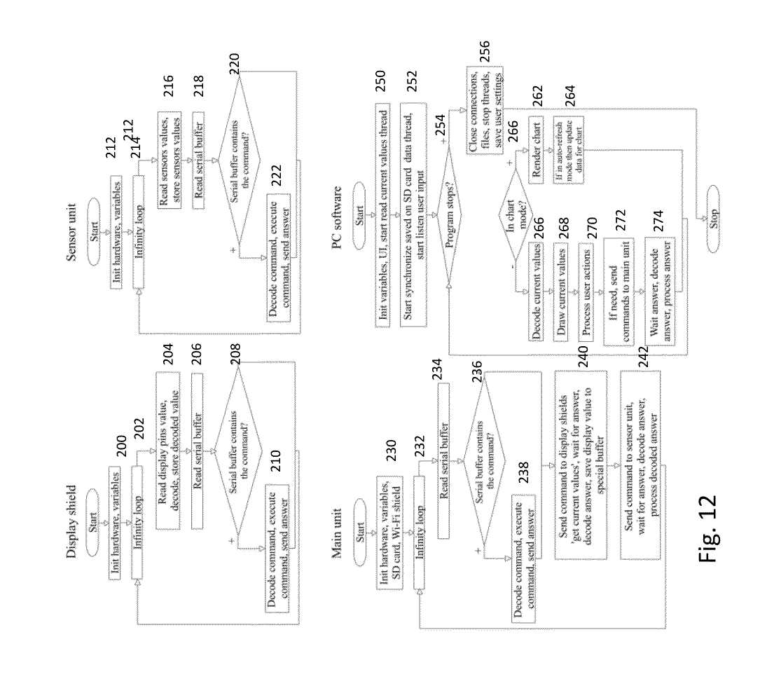

With reference to FIG. 12, one embodiment of the software or firmware to control the enclosure 2 is shown. The display hardware 200 first initializes the hardware and variables, at which point it enters a loop 202 wherein it first reads and decodes the values coming into the display from the microcontroller or display interface, and stores the decoded values at step 204. It then reads the serial buffer at step 206. If the serial buffer contains the command at step 208, then at step 210 the command is decoded and executed, otherwise the loop returns to the start 202.

The sensor unit software or firmware initializes the hardware and variables at step 212. It then enters a loop at 214 wherein the sensor values are read and stored by the sensor controller at step 216. Then at step 218 the serial buffer is read. If the serial buffer contains the command at step 220, then at step 222 the sensor controller decodes and executes the command. The role of the sensor controller can also be performed by the microcontroller.

The microcontroller initializes variables, the SD card if one is present, and the Wi-Fi shield at step 230. Then it enters a loop at step 232, wherein it reads the serial buffer at step 234. If the buffer contains a command at step 236, then the command is decoded and executed at step 238. If the buffer contains no command, then at step 240 a command is sent to the display to “get current values”, and the microcontroller waits for an answer, decodes the answer and saves the display value to a special buffer at step 242. In step 244, the command is sent to the sensor unit, and after waiting for the answer, the answer is decoded and processed. Thereafter, the loop is repeated, returning to step 232.

With further reference to FIG. 12, the PC software for interfacing with the enclosure starts with initializing variables, the user interface and reading current values at step 250. At step 252, the PC software synchronizes with data saved on a SD card, if present, and listens for user input. At step 254, the PC determines if the program stops at step 254. If it does, then at step 256 connections are closed, threads are stopped and user settings are saved. At step 258, the PC software stops. If the program does not stop at step 254, then at step 260 the PC determines if it is in chart mode. If so, then the chart may be rendered at step 262 and the chart updated at step 264 if in auto-update mode. If not in chart mode at step 260, then the PC program decodes current values at step 266, draws current values at step 268, processes user actions at step 270, sends commands to microcontroller if necessary at step 272, and waits for an answer and processes that answer at step 274. Thereafter, the loop returns to step 254.

1. A self-contained smart electrical panel enclosure comprising:
a. two or more circuit breakers each having terminals;
b. a back plate for mounting breakers and other devices;
c. an openable protective breaker cover within a larger openable protective enclosure cover over the breakers and other devices;
d. a power meter-display for each breaker connected to the terminals, for monitoring the circuit characteristics of the panel mains and individual loads; and
e. an interface connected to each power meter-display, for displaying the circuit characteristics.

2. The electrical panel enclosure of claim 1 wherein the power meter-displays have one or more buttons for changing to values shown, simultaneously and independently reading the values displayed.

3. The electrical panel enclosure of claim 1 further comprising a transfer switch to transfer from a first source to a second, other alternative power source, wherein the transfer switch automatically transfers to the second source when the first source fails.

4. The electrical panel enclosure of claim 1 further comprising:
a. One or more relays for prioritizing and timing loads, wherein certain loads are prioritized and timed by connection to the relays.

5. The electrical panel of claim 4 further comprising a microcontroller for controlling loads, wherein the relays are power relays, current control relays, timer relays, or time delay relays that are controlled by loads or a microcontroller.

6. The electrical panel of claim 5 wherein the microcontroller is connected to the power meter-displays and receives information on circuit characteristics for logging and viewing.

7. The electrical panel enclosure of claim 1, further comprising environmental sensors for sensing the environment in and around the panel detecting abnormal environments, and a signal apparatus for signaling and communication of an abnormal environment.

8. The electrical panel of claim 1 further comprising one or more breaker without corresponding power meter-displays.

9. An exterior DC service entrance for using an automobile as a generator for a building, for providing automotive power to a building electrical panel, comprising:
a. a transfer switch to switch between a house power source and an automotive power source, electrically connected to the electrical panel;
b. an inverter system for converting DC power to AC power connected to the transfer switch;
c. an alternator overload protection circuit connected to the inverter system, for connecting to the automotive power source
wherein the automotive power source is electrically connected to the protection circuit, and the transfer switch transfers automotive power to the electrical panel.

10. The DC service entrance of claim 9, further comprising a prioritization system for prioritizing loads.

11. The DC service entrance of claim 9, further comprising a second electrical panel for emergency circuits.

12. The DC service entrance of claim 9, further comprising a current sensor and a power relay connected between the automotive power source, the transfer switch, and the inverter system, wherein the power relay stops current flow when the current sensor signals an excessive current draw.

13. The DC service entrance of claim9, further comprising a weatherproof enclosure having a lockable enclosure cover, wherein the electrical panel, the transfer switch, the inverter system and the protection circuit are in separate enclosures within the building.

14. The DC service entrance of claim 9, wherein the electrical panel, the transfer switch, and the protection circuit are in one enclosure.

15. A load miser connected to an electrical panel, comprising:
a. an enclosure;
b. two or more relays;
c. one or more preferred circuit breakers within the enclosure, connected to and controllable by at least one relay; and
d. one or more non-preferred circuit breakers within the enclosure, connected to and controllable by at least one relay.

16. The load miser of claim 15 wherein the enclosure is pre-wired for connection with to an electrical panel having a wiring kit comprising wire labels, compression fittings, heat shrink to join wires, and mounting screws.

17. The load miser of claim 15 further comprising a microcontroller for controlling the relays.

18. The load miser of claim 15further comprising current sensors for monitoring load on the preferred circuit breakers.

19. The load miser of claim 15 further comprising of time delay relays for controlling sensitive or compressive loads.

20. An electrical system for alternative power sources, comprising:
a. an electrical panel enclosure comprising:
i. two or more circuit breakers each having terminals;
ii. a back plate for mounting breakers and other devices;
iii. an openable protective breaker cover within a larger openable protective enclosure cover over the breakers and other devices;
iv. a power meter-display for each breaker connected to the terminals, for monitoring the circuit characteristics of the panel mains and individual loads;
v. an interface connected to each power meter-display, for displaying the circuit characteristics;
b. an exterior DC service entrance for using an automobile as a generator for a building, comprising:
i. a transfer switch to switch between a house power source and an automotive power source, electrically connected to the electrical panel;
ii. an inverter system for converting DC power to AC power connected to the transfer switch;
iii. an alternator overload protection circuit connected to the inverter system, for connecting to the automotive power source;
wherein the automotive power source is electrically connected to the protection circuit, and the transfer switch transfers power from the automotive power source to the electrical panel; and
c. a load miser connected to the electrical panel, comprising:
i. a load miser enclosure;
ii. two or more relays;
iii. one or more preferred circuit breakers within the enclosure, connected to and controllable by at least one relay; and
iv. one or more non-preferred circuit breakers within the enclosure, connected to and controllable by at least one relay;
for preferring loads within the building.
